(19) United States
(12) Patent Application Publication
(10) Pub. No.: US 2003/0195769 A1
(43) Pub. Date: Oct. 16, 2003

(54) Methods and systems for providing an employee medical expense spending account with employer cost reimbursement

(75) Inventor: Thomas Michael Francis, Santa Rosa, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: MESA Insurance Administrators, Inc., Santa Rosa, CA

(21) Appl. No.: 10/122,588

(22) Filed: Apr. 15, 2002

(51) Int. Cl. G06F 17/60

(52) U.S. Cl. 705/2; 705/39

(57) ABSTRACT

Disclosed are methods and systems whereby an employer provides health insurance benefits to employees by a combination of (1) a high deductible insurance policy and (2) an employer-funded medical expense spending account (MESA) for each employee. The MESAs cover some health care expenses below the insurance policy deductible. Employee health care expenses below the deductible but beyond that covered by the MESA are paid for out of the employee's pocket. At the close of each plan period, any unused employer contributions remaining in the MESA are divided between the employer and the employee. The employer's share goes to cover, at least in part, the employer's health care expenditures. The employee's share is given to the employee as income. An employer may use an external administrator to establish and maintain MESAs, to process claims against MESAs, and to disburse funds remaining in the MESAs at the close of the plan period.

### TECHNICAL FIELD

The present invention relates generally to health insurance, and, more particularly, to employee medical expense spending accounts.

### COPYRIGHT NOTICE AND PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the MESA Plan Document as included below: Copyright © 1994, 1999, 2001, MESA Insurance Administrators, Inc., All Rights Reserved.

### BACKGROUND OF THE INVENTION

Health insurance has been part of employee compensation for the better part of fifty years. During this period, the cost of health insurance has risen until it is the second largest component of an employee's compensation. In paying for rising health insurance costs, an employer uses finds that would otherwise be available to increase other components of the employee's compensation, such as salary. As a result, employers are looking to alternative health insurance plans that maintain the level of compensation given to employees while reducing the cost of health insurance as a percentage of employee compensation and while stabilizing the cost of health insurance over an extended period.

The cost of health insurance rises, in part, because of differences in the way employers and employees value health insurance benefits. Currently, an employer judges the value of these benefits based on the cost of providing the insurance and on the insurance's effectiveness. An employee judges the value of health insurance benefits based on the out-of-pocket expenses the employee may incur. As a result, the employee wants coverage with low office co-payments and with low out-of-pocket exposure, regardless of benefit restrictions. Because the employer-paid insurance policy covers so many services, the employee has no incentive to reduce health care expenditures. This leads to an overuse of health care services which increases the employer's premium costs for the insurance plan.

Some employers have responded to this dilemma by bringing their employees back in as major participants in the costs of their own health care. Ordinary health care expenses are separated from catastrophic care. The latter is covered by a traditional, employer-provided insurance plan, but one with a high deductible. Ordinary, non-catastrophic expenses, those below the high deductible, are covered, first, by a medical expense spending account (MESA), set up for the employee and funded by the employer, and, second, by the employee's own pocket. At the end of each year, any money left unused in the MESA is turned over to the employee as income. The potential for this extra income, combined with the exposure of the employee's pocket to health care expenses, gives the employee an incentive to reduce the use of ordinary health care services. The employer still covers some ordinary health care expenses, and the employee is still insured for catastrophes, but that insurance is much less expensive for the employer to provide because it does not cover ordinary, non-catastrophic expenses. The reduced cost of the high deductible insurance plan more than offsets the cost to the employer of finding the MESAs. The employer's health insurance savings can be passed on to the employees in the form of higher salary.

While MESAs are an important advance over traditional, full coverage, low deductible insurance, the fact that all unused employer contributions to a MESA are turned over to the employee as income at the end of each year may lead to misallocation of funds. What has been needed is a method that extends the benefits offered by MESAs while more efficiently controlling the employer's contributions to employees' MESAs.

### SUMMARY OF THE INVENTION

The above problems and shortcomings, and others, are addressed by the present invention, which can be understood by referring to the specification, drawings, and claims. According to the present invention, an employer provides health insurance benefits to employees by a combination of (1) a high deductible insurance policy and (2) an employer-funded MESA for each employee. The MESAs cover some health care expenses below the insurance policy deductible. Employee health care expenses below the deductible but beyond that covered by the MESA are paid for out of the employee's pocket. The MESAs are established and maintained in conformity with applicable tax laws. At the close of each plan period, typically once a year, any unused employer contributions remaining in the MESA are divided between the employer and the employee. The employer's share goes to cover, at least in part, the employer's health care expenditures such as the premium on the high deductible insurance policy. The employee's share is given to the employee as income.

An employer may use an external administrator to establish and maintain the MESAs, to process claims against the MESAs, and to disburse finds remaining in the MESAs at the close of the plan period. The administrator may also be involved in securing the high deductible insurance policy and in providing accounting reports about use of the MESAs.

### BRIEF DESCRIPTION OF THE DRAWINGS

While the appended claims set forth the features of the present invention with a particularity, the invention, together with its objects and advantages, may be best understood from the following detailed description taken in conjunction with the accompanying drawings of which:

FIGS. 1a and 1b are schematic diagrams showing the participants in a combination MESA/High Deductible Health Savings (HDHS) insurance plan; FIG. 1a shows how the MESA and the HDHS are funded; FIG. 1b shows how finds flow to health care providers;

FIGS. 2a and 2b together form a flowchart of an exemplary method of paying claims against the MESA/HDHS plan;

FIG. 3 is a schematic diagram showing how funds remaining in the MESAs at the close of a plan period may be distributed;

FIG. 4 is a flowchart of an exemplary method of distributing funds remaining in the MESAs at the close of a plan period; and

FIG. 5 is a schematic diagram showing how an administrator of the MESA/HDHS plan may communicate with components of the plan.

### DETAILED DESCRIPTION OF THE INVENTION

Turning to the drawings, wherein like reference numerals refer to like elements, the invention is illustrated as being implemented in a suitable computing environment. The following description is based on embodiments of the invention and should not be taken as limiting the invention with regard to alternative embodiments that are not explicitly described herein. Section I details exemplary money flows in a combined MESA/HDHS insurance plan. For reference's sake, Section II presents an exemplary MESA plan document.

I. Exemplary Money Flows in a Combined MESA/HDHS Insurance Plan

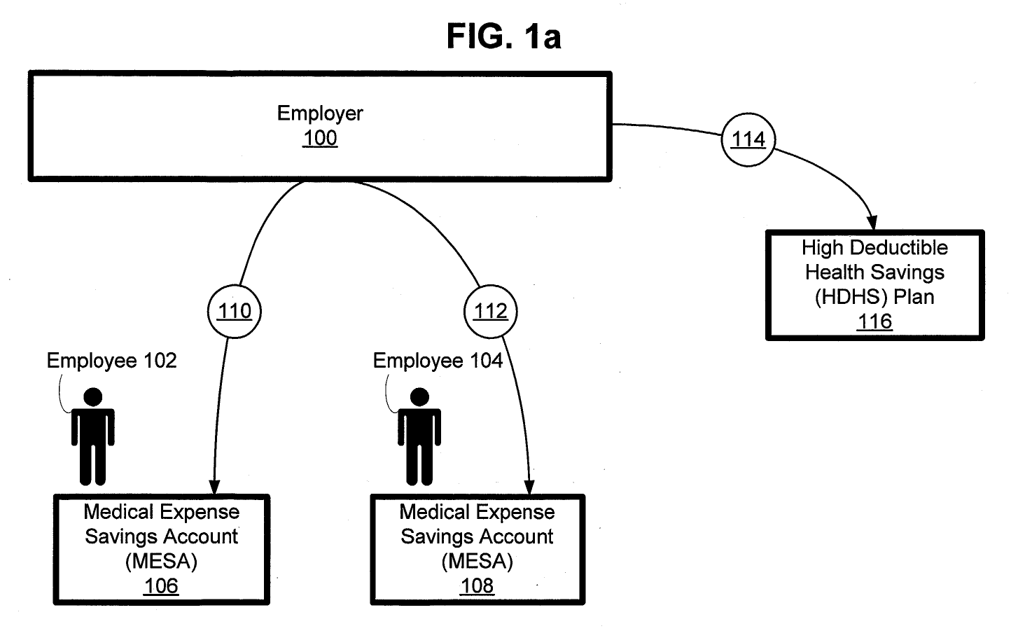

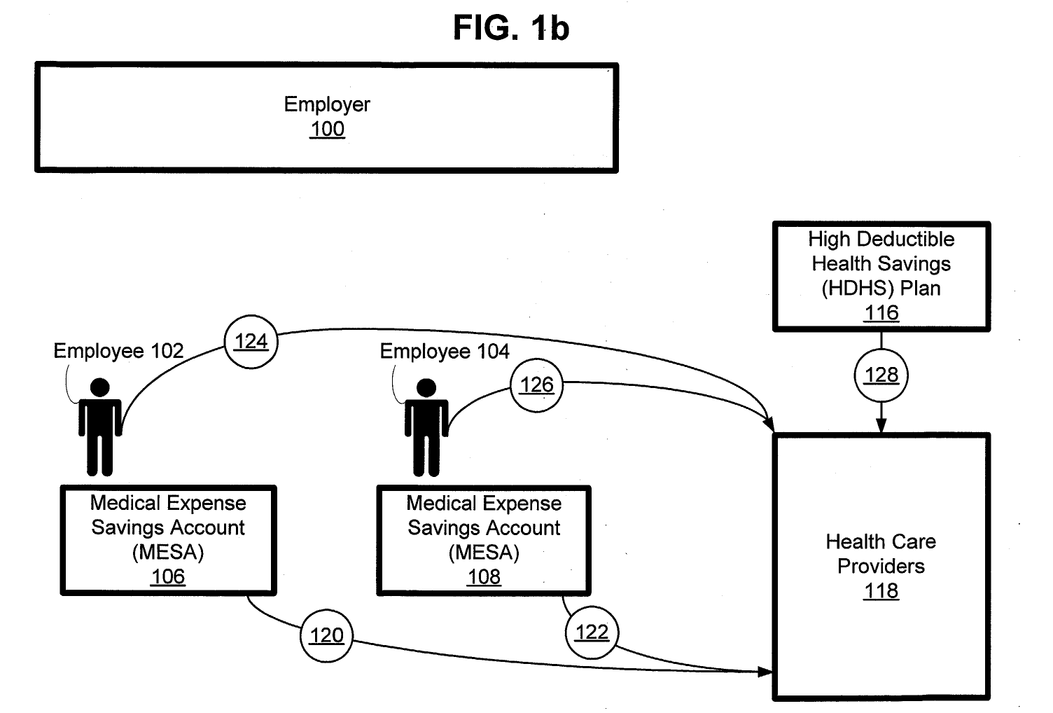

FIG. 1a introduces some of the participants in an exemplary implementation of a MESA/HDHS health care plan according to the present invention. An employer 100 is shown with two employees, 102 and 104. This example is not meant to be limiting as the invention may be practiced with any type of organization or group and with any number of members thereof. For each employee 102 and 104 participating in the health care plan, the employer 100 establishes a MESA, 106 and 108 respectively. MESAs are defined contribution accounts established under the Employee Retirement Income Security Act of 1974. The employer 100 uses the MESAs 106 and 108 to reimburse the employees 102 and 104, respectively, when they incur qualified health care expenses. Internal Revenue Service Code Section 213 defines which health care expenses are “qualified” for purposes of the MESAs. The operation of the MESAs, along with the HDHS, are described in detail below.

Periodically throughout each plan period (typically covering one year), the employer 100 transfers finds 110 and 112 into the MESAs 106 and 108. For purposes of the present example, the employer 100 contributes $1000 once a year to each MESA. Meanwhile, the employer 100 negotiates for an HDHS plan 116 to cover catastrophic health care expenses incurred by the participating employees 102 and 104. The employer 100 pays a premium 114 for the HDHS 116. The premium 114 is based, in part, on the number of participating employees and on the amount of the HDHS deductible. In a combined MESA/HDHS plan, the employer 100 pays a lower premium 114 by accepting a higher HDHS deductible. For purposes of this example, let the HDHS deductible be $3000 for each participating employee.

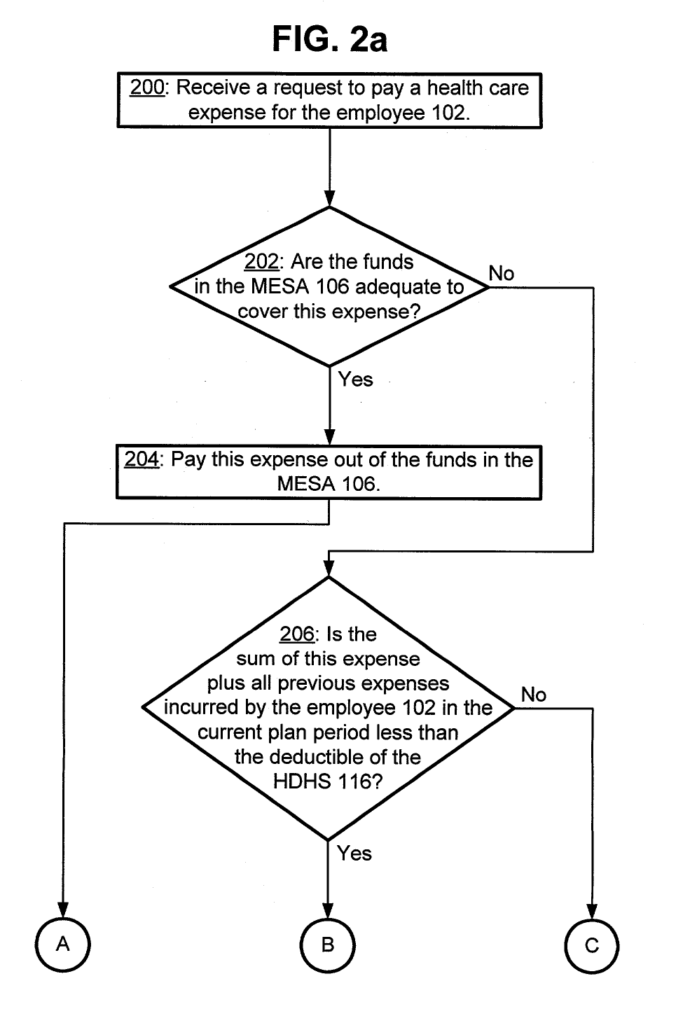

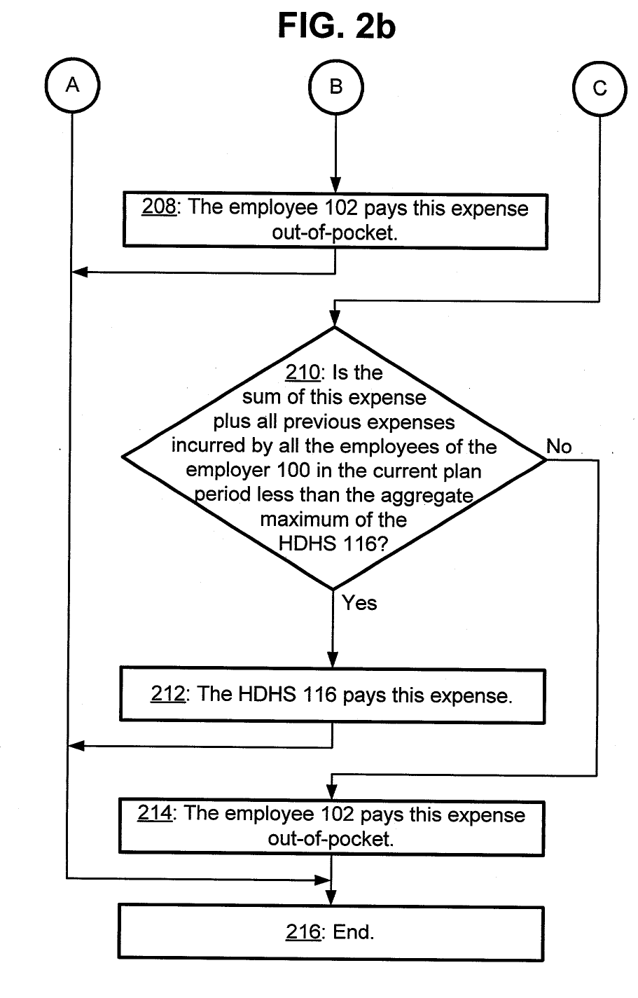

FIG. 1b presents an overview, and FIGS. 2a and 2b present details, of how funds in the MESA/HDHS plan are used to pay for health care expenses. The set of all health care providers is represented by the box 118. Embodiments of the MESA/HDHS plan may place restrictions on the benefits provided under the plan and may restrict the set of acceptable health care providers. For examples of these restrictions, see Section II which presents a fully detailed, exemplary MESA plan document. Such restrictions, though an important part of any health insurance plan, are not a focus of the present discussion.

The employer-funded MESA 106 provides first dollar funds, via money flow 120, for health care expenses incurred by the participating employee 102. If the employee 102's health care expenses exceed the funds in his MESA 106 during the plan period, he begins paying for additional expenses out of his own pocket (money flow 124). If the sum of the employee 102's health care expenses (whether paid out of his MESA 106 or paid out-of-pocket) exceeds the deductible of the HDHS 116, then the HDHS 116 takes over and, via money flow 128, pays the additional expenses. (But see the important caveat on step 206 of FIG. 2a below.)

FIGS. 2a and 2b provide the details behind the money flows of FIG. 1b. Together, FIGS. 2a and 2b form a flowchart of one way to use various funds when processing a claim against the MESA/HDHS plan. In step 200, the employee 102 has incurred a health care expense, and the request to pay for the expense comes into the plan. If the expense is not qualified under the plan, then, of course, the employee 102 pays the expense out of his own pocket (not shown). For a qualified expense, step 202 first checks the amount of funds remaining in the employee 102's MESA 106. If the remaining funds are adequate to cover the expense, then the expense is paid out of the MESA in step 204. If, on the other hand, the funds in the MESA are completely depleted, then the procedure goes to step 206. (In reality, steps 204 and 206 are not mutually exclusive: if funds remaining in the MESA 106 are only sufficient to pay part of a qualified expense, then that part is paid out of the MESA 106 and the remaining part is treated beginning at step 206. For clarity's sake, this case is not depicted in FIG. 2a.)

In step 206, a sum is calculated of the qualified expenses paid by the employee 102 during the current plan period. This sum includes all payments out of the MESA 106 and out of the employee 102's pocket. The sum is compared against the per-employee deductible for the HDHS plan 116. If the sum is less than the deductible, then the procedure continues at step 208 of FIG. 2b. In that step, the employee 102 pays the expense out of his own pocket. If, on the other hand, the sum of payments already made for qualified expenses exceeds the deductible, then the procedure continues at step 210 of FIG. 2b.

Important Caveat on Step 206 of FIG. 2a: In some embodiments of the MESA/HDHS plan, the definition of a “qualified” expense for the MESA 106 differs from the definition of a “qualified” expense for the HDHS 116. The MESA definition of “qualified” is impliedly used in step 200: non-qualified expenses are paid out of the employee 102's pocket, never entering into the flowchart of FIGS. 2a and 2b. The HDHS 116 definition is used in step 206 when calculating the sum of health care expenses incurred by the employee 102, for purposes of comparing the sum with the HDHS deductible. For example, let the employee 102 incur a $100 expense qualified under the MESA 106 but not qualified under the HDHS 116. That expense is paid either by the MESA 106, if funds remain in the MESA 106 at step 202, or out of the employee 102's pocket. In either case, however, that $100 expense is not included in the sum of employee 102's expenses in step 206.

Returning to FIG. 2b, step 210 is reached if the employee 102's HDHS-qualified expenses during the current plan period have exceeded the deductible of the HDHS plan 116. When the employer 100 negotiates for the HDHS plan 116, one of the terms of the negotiation is the “aggregate maximum” payable under the HDHS plan 116. This is a limit on the sum of all payments made for all HDHS-qualified expenses incurred by all participating employees during the plan period. In our example, considering the small number of participating employees, an aggregate maximum of $2,000,000 may be reasonable. Note that under normal circumstances, this aggregate maximum is never reached: rarely will enough employees of one employer incur such high health care expenses in one plan period to trigger the aggregate maximum. In step 210, the sum of all expenses paid out by the HDHS plan 116 for all participating employees of the employer 100 during the current Plan Year is compared against the aggregate maximum. If, as is almost always the case, the aggregate maximum has not been reached, then the HDHS 116 pays the current expense in step 212. If the aggregate maximum has been reached, then the employee 102 must pay this expense out of his own pocket in step 214. Consider that although step 208 and step 214 look similar, they deal with vastly different circumstances. In step 208, the employee 102 is paying out-of-pocket for relatively normal health care expenses, having exhausted his MESA 106 funds but not yet paying enough to exceed the HDHS plan 116's per-employee deductible. In the very unusual case of step 214, on the other hand, the HDHS plan 116 has itself been exhausted, and the employee 102 is left to pay any further health care expenses.

To recap the effects of the method of FIGS. 2a and 2b, consider the case where all health care expenses qualified under the MESA 106 are also qualified under the HDHS plan 116. Then, using the money figures of our example, the first $1000 of qualified expenses incurred by the employee 102 in each plan period are paid out of the funds that the employer 100 contributes to the MESA 106. The next $2000 in expenses are paid out of the employee 102's pocket. Catastrophic expenses, here defined to be expenses beyond the first $3000, are paid by the employer-funded HDHS plan 116 (until the aggregate maximum is reached).

As described so far, it can be seen that in this combined MESA/HDHS plan, the employer 100 pays for most ordinary health care expenses through the MESA 106, while the employer-funded HDHS plan 116 insures participating employees against catastrophic expenses. Expenses falling in the “gap” between the funds in the MESA 106 and the HDHS deductible are paid by the employee 102 out-of-pocket. This gives the employee 102 an incentive to lower his expenses by wisely shopping for health care. Through this incentive, all participating employees work toward lowering their own, and their employer 100's, cost of health care. This incentive effect is a chief benefit of the MESA/HDHS plan.

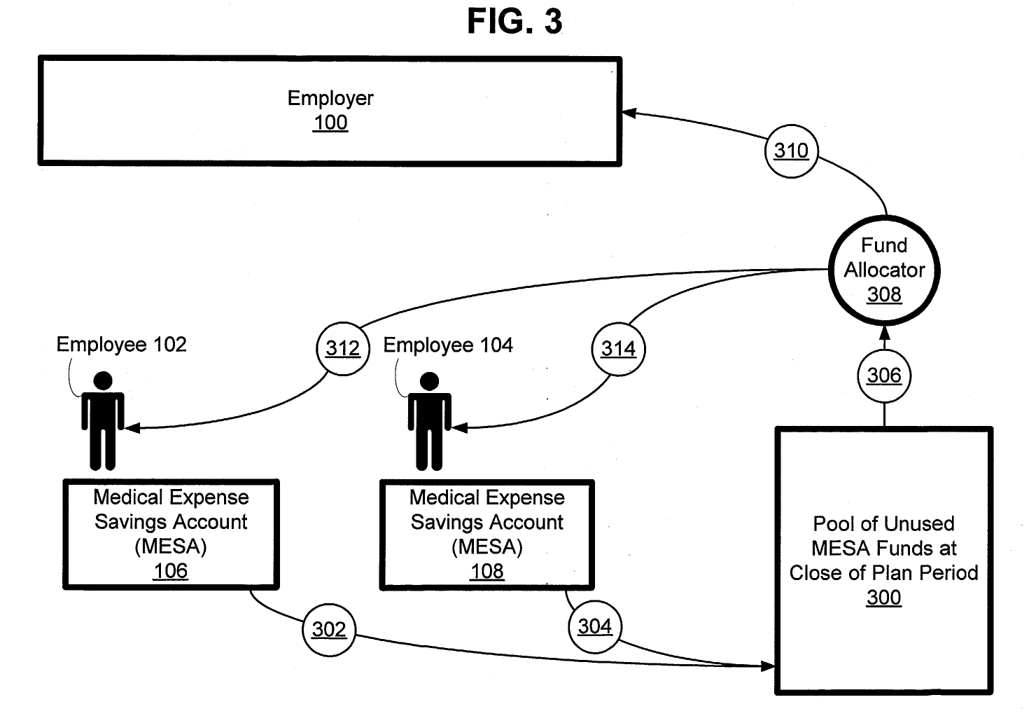

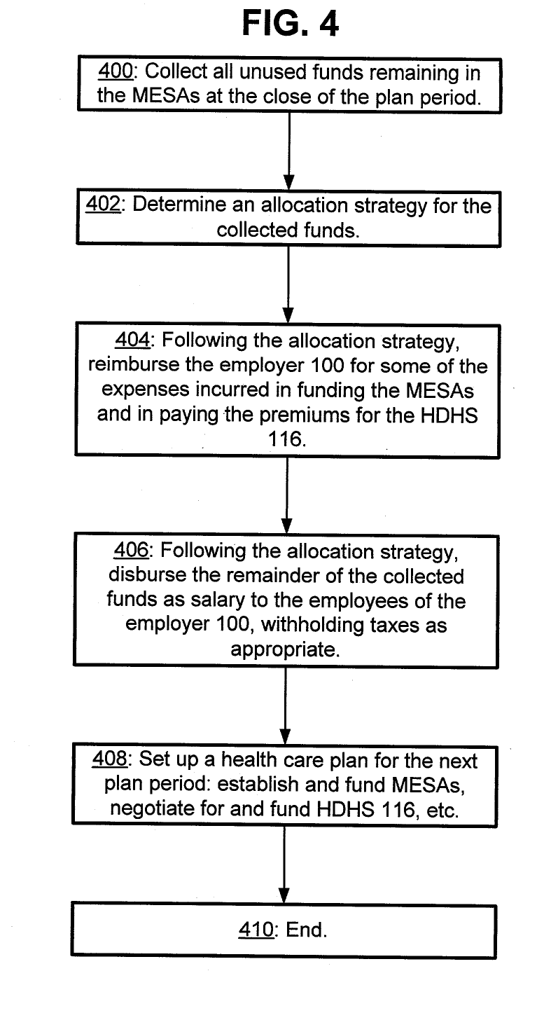

An accounting of finds is made at the close of each plan period. FIG. 3 illustrates the money flows of this accounting, while FIG. 4 is a flowchart detailing the close-of-plan-period accounting procedure. By the close of a plan period, the employer-provided funds may have been exhausted in some MESAs but not in others. All remaining MESA funds are collected, as depicted by money flows 302 and 304 of FIG. 3 and step 400 of FIG. 4, and collected into a fund pool 300. According to an aspect of the present invention, a strategy is determined for allocating the funds in the pool 300 (step 402). Following the strategy, the allocator 308 returns some of these funds to the employer 100 via flow 310 (step 404). These funds partially reimburse the employer 100 for its expenses in funding the MESA/HDHS health care plan. Specifically, these funds help to offset the costs of funding the MESAs (money flows 110 and 112 of FIG. 1a) and of paying the HDHS premium 114. The remainder of the collected funds is paid out as extra salary to the participating employees 102 and 104, via money flows 312 and 314 (step 406). The next plan period begins in step 408 where the employer 100 funds MESAs for participating employees and negotiates for the HDHS plan 116 for the new plan period.

The key to the method of FIG. 4 is the allocation strategy. In a first strategy, no funds are used to reimburse the employer 100. Rather, each participating employee is given, as salary, any unused funds remaining in his MESA. This close-of-plan-period pay out works in addition to the “gap” incentive mentioned two paragraphs above in making an employee want to wisely use his MESA funds. This strategy can be bettered, however. As a second strategy, step 404 of FIG. 4 is followed by reimbursing some of the employer 100's expenses. This strategy may help the employer 100 to justify greater expenditures in the next plan period, possibly in the form of greater MESA funding. A third strategy ties each employee's close-of-plan-period payout to the total amount of funds remaining in all MESAs. In a “pure” example, each participating employee is given an equal share in the pool 300 of remaining MESA funds. This allocation strategy furthers a “team spirit” among participants where, through peer pressure, each participant urges other participants to intelligently use the funds in their MESAs so that everyone can share a larger pool at the close of the plan period. Unfortunately, in this “pure” form of the third strategy, each participating employee has less of an incentive than in the first strategy to keep his own health care expenses low. The best strategy combines elements of the three strategies noted above. With a carefully adjusted mix of these three strategies, a MESA/HDHS plan provides for comprehensive health care benefits while giving the plan participants an incentive to use health resources wisely and thus to keep costs low.

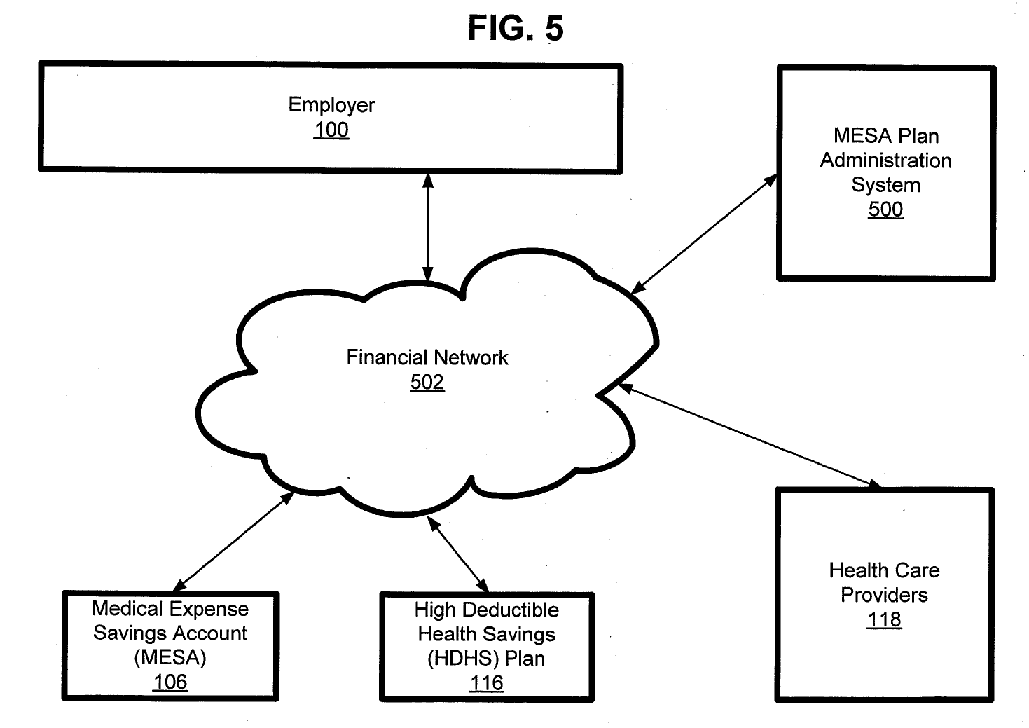

FIG. 5 shows that the employer 100 may contract out the administration of the MESA/HDHS plan. A MESA plan administration system 500 communicates via a financial network 502 (which may comprise, for example, the postal service or the Internet) with the employer 100, with the MESAs 106, with the HDHS plan 116, and with health care providers 118. At the opening of a plan period, the administration system 500 may help the employer 100 to establish and fund the MESAs 106 and to negotiate for the HDHS 116. During the plan period, the administration system 500 may process claims (e.g., by following the method of FIGS. 2a and 2b) and provide the employer 100 with monthly health insurance usage reports. Finally, at the close of the plan period, the administration system 500 may pool the remaining MESA funds and allocate them according to a strategy agreed upon by the employer 100.

II. An Exemplary MESA Plan Document

For the sake of reference, this section provides a complete MESA plan document. This document is included to show examples of qualified MESA expenses and exclusions, participation requirements, and other important provisions. It is exemplary only and is not meant to limit the claimed invention in any way.

USUAL, CUSTOMARY, and REASONABLE (UCR): In general UCR means the normal and necessary charges made by providers of service with like experience, education, and training in the same geographic area. Charges exceeding UCR are not considered covered expenses for benefits under the Plan. Thus, if a provider charges more than the UCR amount, the Covered Person will have to pay the excess.

A. Explanation of Benefits

The Medical Expense Spending Account (MESA) is a self-funded ERISA plan, established by the employer for the purpose of reimbursing its employees for eligible medical expenses they incur under their high deductible medical insurance plan. Claims submitted are eligible based on provisions of the Internal Revenue Service Code Section 213.

A.1. General Information

All benefits are subject to the provisions of Section 213 of the Internal Revenue Service Code.

Under the Plan, Covered Persons are free to choose their own physician and their own hospital, provided they meet the definitions included in the Plan. However, the choice of the provider may affect the cost of services.

Coverage is provided for medically necessary services or supplies, that is, services which are broadly accepted professionally as essential to the treatment of illness or injury. The Plan pays benefits up to the aggregate maximum amounts shown in the Schedule of Benefits for each Plan Year. A Plan Year commences on February 1 and ends on January 31 of the following year.

MAXIMUM ANNUAL BENEFIT: The maximum benefit for each Covered Employee (including Covered Dependents, if any) is $1,500 each Plan Year. This benefit accrues at the rate of $125.00 per employee per month during each Plan Year.

A.2. Covered Expenses

Following is a list of examples of the types of Covered Expenses allowed under Section 213 of the Internal Revenue Service Code. This list is not intended to be all-inclusive:

| | |
|---|---|
| Abortion | Lifetime Care |
| Acupuncture | Lodging |
| Alcoholism | Long Term Care |
| Ambulance | Meals |
| Artificial Limbs | Medical Information Plan |
| Artificial Teeth | Medical Services |
| Birth Control Pills | Medicines (Prescribed) |
| Braille Books & Magazines | Nursing Homes |
| Car (special hand controls and other | Nursing Services |
| special equipment) | |
| Chiropractor | |
| Christian Science Practitioner | Operations |
| Contact Lenses | Optometrist |
| Crutches | Osteopath |
| Dental Treatment | Oxygen, inccluding equipment |
| Drug Addiction | Psychiatric Care |
| Eyeglasses | Psychoanalysis |
| Guide Dogs or Other Animals | Psychologist |
| Insurance Premiums | Sterilization |
| Hearing Aids | Surgery |
| Hospital Services | Special Phones & TVs |
| Laboratory Fees | Therapy |
| Learning Disabilities | Transplants |
| Legal Fees (related to Mental Illness) | Wheel Chairs |
| X-Rays | |

A.3. Maternity Benefits

1. Maternity benefits are covered the same as any illness by the Plan, except as stated in 2 below.

2. Expenses in connection with the pregnancy of a Covered Dependent child are excluded.

A.4. Contraceptive Services

For the Covered Employee and his or her Covered Spouse, contraceptive services means Physician-delivered, Physician-supervised, Physician assistant-delivered, certified nurse midwife-delivered, or nurse-delivered medical services intended to promote the effective use of prescription contraceptive supplies or devices to prevent unwanted pregnancy. Contraceptive services also include tubal ligation or vasectomy. These services are covered under the Plan as any other illness.

B. Exclusions

Unless specific exceptions to the following limitations are made, no benefits shall be payable for or on account of:

1. Any accidental bodily injury or sickness for which the claimant is not under the care of a Physician.

2. Any services or supplies not provided by or prescribed by a physician. (See definition of a physician.)

3. Any charges which would not be made in the absence of this coverage.

4. Any charges for services or supplies:

A. For which no charge is made.

B. For which the claimant is not normally expected to pay.

C. Received by a claimant which are or may be obtained without cost to such individual in accordance with the laws or regulations of any government or government agency, except to the extent, if any, that a charge is made which the individual is legally required to pay.

5. Charges for medical or surgical procedures that are in excess of Usual, Customary and Reasonable charges as determined by the Plan.

6. Charges by Preferred Providers in excess of negotiated fees.

7. Charges incurred prior to the effective date of coverage or after coverage has ended.

C. Eligibility and Enrollment

C.1. Coverage—Employees

Coverage for all Eligible Employees will begin on the first day of the calendar month coinciding with or next following commencement of full-time employment provided the employee has:

1. Met the eligibility requirements of the Plan; and

2. Submitted an enrollment form; and

3. Is actively at work; and

4. Seasonal and part-time employees are not eligible.

C.2. Late Enrollment—After an Eligible Person's Initial Eligibility Date

“Late Enrollment” means an eligible employee or dependent who has declined health coverage under this Plan at the time of the initial enrollment period provided under the terms of this Plan and who subsequently requests enrollment in this Plan. However, an eligible employee or dependent shall not be considered a late enrollee if:

1. The individual meets ALL of the following requirements:

A. The individual was covered under another employer health benefit plan at the time the individual was eligible to enroll.

B. The individual certified, at the time of the initial enrollment that coverage under another employer health benefit plan was the reason for declining enrollment, provided that, if the individual was covered under another employer health plan, the individual was given the opportunity to make the certification required by this subdivision and was notified that failure to do so could result in later treatment as a late enrollee.

C. The individual has lost or will lose coverage under another employer health benefit plan as a result of termination of employment of the individual or of a person through whom the individual was covered as a dependent, change in employment status of the individual or of a person through whom the individual was covered as a dependent, termination of the other plan's coverage, cessation of an employer's contribution toward an employee or dependent's coverage, death of a person through whom the individual was covered as a dependent, or divorce.

D. The individual requests enrollment within 30 days after termination of coverage, or cessation of employer contribution toward coverage provided under another employer health benefit plan.

2. The individual is employed by an employer that offers multiple health benefit plans and the individual elects a different plan during an open enrollment period. The open enrollment period of each group may only occur on the group's anniversary date.

3. A court has ordered that coverage be provided for a spouse or minor child under a covered employee's health benefit plan and request for enrollment is made within 30 days after issuance of the court order.

4. The Plan allows a Special Enrollment for an employee who initially declined coverage, but who later acquires a new dependent through either marriage, the birth of a child, or the adoption or placement for adoption of a child under nineteen years of age. Such employees may enroll themselves and their newly acquired dependent(s) if application for coverage is made within 30 days of the date of marriage, birth, adoption, or placement for adoption.

Employees who do not cover themselves or their dependents within 31 days of being eligible for coverage, will be required to provide satisfactory evidence of good health, at the employee's expense, when application is made for enrollment. Coverage will become effective on the date the application is approved for coverage by the Contract Administrator.

C.3. Reinstatement

If coverage for a Covered Employee under the Plan ended due to termination of employment or reduction in hours, and if such Covered Employee is rehired or returns to an eligible status within one (1) year of termination, the Employee must RE-ENROLL not later than the first day of the month following rehire for full time work, otherwise such Employee will be considered as a new employee/late entrant and must satisfy all requirements pertaining to new employees or late entrants.

C.4. Coverage—Dependants

Initial Enrollment: Coverage for an Employee's Dependents, which is to become effective as of the same date as the Employee's coverage, will do so if an enrollment form is submitted.

C.5. After a Covered Employee'S Initial Eligibility Date

1. Employees with or without current Dependent Coverage under the Plan:

A. Newly acquired Dependents may be added without underwriting approval.

B. The new Dependent must be added not later than the first day of the month following the date the individual becomes an eligible Dependent. If all eligibility requirements are met, coverage will become effective on that same date (the first day of the month following the date the individual becomes an eligible Dependent, as defined).

C. If the new Dependent is a newborn infant, the child must be added within thirty days (30) of birth. However, coverage will be retroactive to the date of birth.

D. If newly acquired Dependents are not added on a timely basis, as described above, their future acceptance will be subject to medical underwriting approval before coverage becomes effective.

2. All Employees: Current Dependents who have not been previously covered under the Plan: Dependents who are added after the date they first become eligible for coverage under the Plan are subject to medical underwriting approval before coverage becomes effective.

C.6. Dependants Cease to be Eligible on:

1. The date that eligibility for the Employee ceases; or

2. The last day of the month in which the Dependent ceases to be eligible as a Dependent, as set forth under the definition of Dependent.

D. Termination of Coverage

D.1. For All Covered Persons

Coverage under the Plan will terminate on the earliest of the following dates:

1. The date the Plan terminates;

2. The end of the last period for which any required contribution has been made;

3. The date after which the Employee is no longer eligible for coverage;

4. The last day of the calendar month in which the Employee's employment with the Employer ends.

D.2. For Dependants

Dependent's coverage will automatically terminate on the earliest of:

1. The date the Employee's coverage ends;

2. The end of the month in which the Dependent ceases to be a Dependent, as defined in the Definitions section; or

3. The end of the last period for which any required contribution has been made.

A Dependent Child will not cease to be a Dependent solely because of age if the child is not capable of self-sustaining employment due to mental incapacity or physical handicap that began before the age limit was reached and is dependent on the Employee for support. The Administrator will ask for proof of the eligible child's incapacity and dependency within two months of the date the Dependent would otherwise cease to be covered. The Administrator may require the same proof again, but the Administrator will not ask for more than once a year after this coverage has been continued for two (2) years. This continued coverage will end on the earliest of the following dates:

1. On the date the Plan ends; or

2. On the date the incapacity or dependency ends; or

3. On the last day of the last month for which the required contribution for the child was paid.

E. Definitions

ACCIDENTAL BODILY INJURY means an injury effected solely and independently of all other causes, through external, violent and accidental means, or as a result of exposure to the elements.

ACTIVELY AT WORK/ACTIVELY WORKING means the Employee is performing all the regular duties of his or her occupation for the Employer for at least forty (40) hours per week, except that an Employee shall be deemed actively working on each day of a regular paid vacation, or on a regular non-working day, provided he or she was actively at work on his or her last preceding regular working day. In no event will an Employee be considered to be actively working if he or she is totally disabled or otherwise not physically able to perform all the duties of his or her employment.

COVERED PERSON means a Covered Employee or a Covered Dependent.

CUSTODIAL CARE means care provided primarily for the maintenance of the patient or which is designed essentially to assist the patient in meeting his or her activities of daily living and which is not primarily provided for its therapeutic value in the treatment of a sickness or accidental bodily injury. Custodial care includes, but is not limited to, help in walking, bathing, dressing, feeding, preparation of special diets, and supervision over self-administration of medications not requiring constant attention of trained medical personnel.

Eligible Dependent Means:

1. The Employee's legally married spouse. Proof by copy of a valid marriage certificate may be required.

2. The Employee's unmarried children, including stepchildren, legally adopted children, and children for whom a Covered Employee or a Covered Spouse has been declared Court Appointed Guardian, less than nineteen (19) years of age, who are financially dependent upon the Employee or for whom the Employee must contribute support by order of the Court.

3. The Employee's unmarried children, under age nineteen (19); or under age twenty-five (25), provided they are financially dependent upon the employee AND they are regularly attending an accredited educational institution as a full-time student, maintaining at least twelve (12) units, or the definition of full-time as used by the accredited learning institution, whichever is greater. The Plan shall request proof supplied by the accredited institution each year.

4. The Employee's unmarried children, regardless of age, residing with, and dependent upon, the Employee for support, who are incapable of self-support because of mental or physical incapacities that existed prior to reaching age 19 while covered under this Plan.

Exceptions to Dependent Definitions:

1. A Dependent who is in the service of the armed forces, or who lives outside the Continental United States, is not eligible as a Dependent.

2. Foster Children and children for whom the Employee or his/her spouse is not a legal guardian are not eligible as Dependents.

Qualifying evidence must be presented in the case of the following:

1. DISABLED UNMARRIED CHILD, AGE 19 OR OVER—Initial proof of mental or physical incapacity existing prior to reaching age 19 by means of a licensed Physician's written statement is required. The Administrator may subsequently require proof of the child's incapacity and dependency at reasonable intervals during the two (2) years after attaining termination age. After this two (2) year period, the Administrator may require subsequent proof not more than once each year. The Administrator reserves the right to have such Dependent examined by a doctor chosen by the Administrator to determine the existence of such incapacity. This extension will continue until the earliest of:

A. The date the child ceases to be eligible for reasons other than age,

B. The date the child ceases to be incapacitated, or

C. The 31st day after the date the Administrator requests additional proof of incapacity, if such proof is not furnished.

2. UNMARRIED CHILD, AGE 19 TO AGE 25, ATTENDING SCHOOL—Proof of enrollment by means of a letter from the Registrar's Office of the School, signed by the Registrar, for the Fall or Spring semester.

3. Dependent status, such as a marriage certificate in the case of a new marriage, birth record in the case of a newborn, divorce and remarriage documents in the case of stepchildren, etc.

EXPERIMENTAL means:

1. As to drugs and medicines, those that are not commercially available for purchase, or are not approved by the United States Food and Drug Administration for broad public use; or

2. As to other services or supplies, those that are not approved or accepted as essential to the treatment of illness by the American Medical Association, United States Department of Public Health, the National Institutes of Health, or the United States Surgeon General.

HOSPITAL means only an institution constituted and operated pursuant to law which:

1. Is primarily engaged in providing, for compensation, from its patients and on an inpatient basis, diagnostic and therapeutic facilities for the surgical and medical diagnosis, treatment and care of injured and sick persons by or under the supervision of a staff of physicians; and

2. Continuously provides 24-hour-a-day service by registered graduate nurses (R.N.).

The Term “hospital” does not include any institution or part thereof that is, other than incidentally, a place of rest, a place for the aged, a nursing home, or a convalescent hospital. An institution specializing in care and treatment of mentally ill patients, which is certified by the American Hospital Association (AHA) as a psychiatric hospital, or tubercular patients, which would qualify under this definition as a hospital, except solely for the surgery, will be deemed a hospital under the Plan.

IMMEDIATE FAMILY means a Covered Person's spouse, parents, and children.

MEDICAL NECESSITY means services or supplies that are provided by a hospital, physician, or other provider which are:

1. Appropriate for the symptoms and diagnosis or treatment of the condition, disease, illness, or injury; and

2. Provided for the diagnosis or direct care and treatment of the condition, disease, illness, or injury; and

3. In accordance with the standards of good medical practice; and

4. Not primarily for the convenience of the covered person or his or her physician or provider; and

5. The most appropriate supply or level of service that can safely be provided to the covered person.

MEDICARE means the Health Insurance for the Aged program under Title XVIII of the Social Security Act, as such Act was amended by the Social Security Amendments of 1965 (Public Law 89-97), as such program is currently constituted and as it may be later amended.

MONTH means starting on the first day and ending on the last day of each calendar month.

NON-COVERED EXPENSE means covered charges which are in excess of Usual, Customary, and Reasonable expenses.

NURSE means a registered nurse (R.N.), a licensed practical nurse (L.P.N.), or a licensed vocational nurse (L.V.N.).

PHYSICIAN means a person acting within the scope of his or her license and holding the degree of Doctor of Medicine (M.D.), Doctor of Osteopathy (D.O.), Doctor of Podiatry (D.P.M.), Doctor of Chiropractic (D.C.), Licensed Physical Therapist, Psychologist, Psychiatrist, Audiologist, Speech Language Pathologist, Midwife, and any other medical practitioner who is licensed and regulated by the state or federal agency. For Covered Expense purposes, a Physician cannot be a member of the Covered Person's immediate family.

SURGICAL PROCEDURE means:

1. The specific operations and/or cutting procedures.

2. The incision, excision, or electro-cauterization of any organ or part of the body and the suturing of a wound.

3. The manipulative reduction of a fracture or dislocation, or the manipulation of a joint under general anesthesia, including application of cast or traction.

4. The removal by endoscopic means of a stone or other foreign object from the larynx, bronchus, trachea, esophagus, stomach, urinary bladder, urethra, colon, or ureter or the diagnostic examination by endoscopic means of these organs.

5. The induction of artificial pneumothorax or injection of sclerosing solution.

USUAL, REASONABLE, AND CUSTOMARY CHARGE means an amount charged for medical services and is a reasonable amount which falls within the common range of fees billed by a majority of providers for a procedure in a given geographic region or which is justified based on the complexity or the severity of treatment for a specific case.

F. General Provisions

ENTIRE CONTRACT. The entire contract consists of the Plan Document and any application executed by a Covered Person.

PLAN CHANGES. Changes in this Plan may be made only by amendment signed by an officer of the employer. No agent may change the Plan or waive any of its terms.

CLERICAL ERROR in the information provided by the Employer will not:

1. Invalidate any person's coverage; or

2. Delay a change in any person's coverage; or

3. Maintain any person's coverage beyond the date it would have ceased, had the correct information been furnished.

Upon discovery of a clerical error, the Administrator will correct the records and adjust the contribution on the basis of the correct information. If the Administrator pays claims that it would not have paid had the information been correctly provided, the employee will reimburse the fund for any and all claims paid in error.

Neither the Administrator nor the Employer will be considered an agent of the other for any purpose.

OTHER PARTY REIMBURSEMENT. If an Employee or his Covered Dependent suffers an illness or injury through the act or omission of another party, and if benefits are paid under the Plan due to the illness or injury, the Plan will be reimbursed by the Employee for the benefits paid if recovery is made for such benefits from the liable other party, its insurer, or by any other means. The Plan may file a lien to secure payment and will require the Employee or Dependent to complete forms as necessary to carry out the terms of this provision.

G. Coordination of Benefits

COORDINATION OF BENEFITS explains how other health insurance a Covered Person may have affects coverage under the Plan.

Many people have health coverage provided by more than one plan at the same time. Each plan has rules for coordination of benefits in the event of double coverage to prevent the total amount of all their benefit payments from exceeding the eligible medical expenses for the Covered Service. This provision helps to contain the cost of health care coverage.

All of the health benefits provided under the Plan are subject to this provision. The Administrator will coordinate obligations under the Plan with payments under any other group health insurance a Covered Person may have.

The following words used in this provision have a special meaning to meet the needs of this provision:

1. “Plan” will mean an entity providing group health care benefits coverage or services, whether on an insured or uninsured basis, or by any other following methods:

A. Insurance or any other arrangement for coverage for individuals, including, but not limited to:

i. Hospital indemnity benefits with regard to an amount in excess of $100 per day; and

ii. Hospital reimbursement type plans which permit the insured to elect indemnity benefits at the time of claim.

B. Service plan contracts, group practice, individual practice, and other pre-payment coverage.

C. Any coverage for students which is sponsored by, or provided through, school or other educational institutions, other than accident coverage for grammar school or high school students for which the parent pays the entire premium.

D. Any coverage under labor management trusteed plans, union welfare plans, employer organization plans, and employee benefit plans.

E. Coverage under any governmental program, including Medicare, but not including state programs (Medicaid) which provide benefits for persons not able to pay for their own care.

F. Individual no-fault auto insurance by whatever name called. (NOTE: This contract is always a secondary plan to benefits provided under any mandatory No-Fault Auto Insurance Act in a state where the Covered Person is living.)

2. The term “Plan” will be construed separately with respect to each policy, contract, or other arrangement for benefits or services and separately with respect to that portion of any such policy, contract, or other arrangement which reserves the right to take the benefits or services of other Plans into consideration in determining its benefits.

3. “Allowable Expense” means the Eligible Medical Expense for medically Necessary Covered Services. When a Plan provides benefits in the form of services rather than cash payments, the reasonable cash value of each service rendered shall be deemed to be an Allowable Expense and a benefit paid.

4. “Claim Determination Period” means the Calendar Year.

5. “Primary Plan.” A Plan is the Primary Plan when, in accordance with the rules regarding the order of benefits determination, it provides benefits or benefit payments without considering any other plan.

6. “Secondary Plan.” A Plan is the Secondary Plan when in accordance with the rules regarding the order of benefit determination; it may reduce benefits or benefit payments and/or recover from the Primary Plan benefit payments.

Plans use coordination of benefits to decide which health care coverage program should be the Primary Plan for the Covered Service. If the Primary Plan payment is less than the charge for the Covered Service, then the Secondary Plan will apply its Allowable Expense to the unpaid balance. Benefits payable under another Plan include the benefits that would have been payable if the Covered Person had filed a claim for them. The Secondary Plan will not be required to pay any more than it would have in the absence of this coordination of benefits provision.

Coordination of benefits applies when a Covered Person covered under this Plan is also entitled to receive payment for or provision of some or all of the same Covered Services from another Plan.

Determination Rules establish the order of benefit determination by:

1. Non-Dependent/Dependent. The benefits of the Plan which covers the person as an employee (that is, other than as a dependent) are primary to those of the Plan which covers the person as a dependent.

2. Dependent Child/Parents Not Separated or Divorced. Except as stated in paragraph 3 below, when this Plan and another Plan covers the same child as a dependent of different persons, called “parents”:

A. The Plan of the parent whose birthday falls earlier in the year is primary to the Plan of the parent whose birthday falls later in that year;

B. If both parents have the same birthday, the Plan that covers a parent longer is primary;

C. If the other Plan does not have the rule described above, but instead has a rule based on the gender of the parent, and if, as a result, the Plans do not agree on the order of benefits, the rule in the other Plan will determine the order of benefits.

3. Dependent Child/Separated or Divorced Parents. If two or more Plans cover a person as a Dependent child of divorced or separated parents, benefits for the child are determined in this order:

A. First, the Plan of the parent with custody of the child;

B. Then, the Plan of the spouse of the parent with custody of the child;

C. Then, the Plan of the parent not having custody of the child, and

D. Finally, the Plan of the spouse of the parent without custody of the child.

Notwithstanding paragraphs A, B, C, and D above, if there is a court decree which would otherwise establish financial responsibility for the medical, dental, or other health care expenses with respect to the child, the benefits of a Plan which covers the child as a dependent of the parent with such financial responsibility shall be determined before the benefits of any other Plan which covers the child as a Dependent child.

4. Active/Inactive Employee. A Plan, which covers a person as an Employee who is neither laid off nor retired (or that Employee's Dependents) is primary to a Plan which covers that person as a laid off or retired Employee (or that Employee's Dependents). If the other Plan does not have this rule, and if, as a result, the Plans do not agree on the order of benefits, this paragraph 4 is ignored.

5. Longer/Shorter length of Coverage. If none of the above rules determine the order of benefits, the Plan which covered the Employee longer is primary to the Plan which covered that person for the shorter time period. Two (2) consecutive Plans shall be treated as one (1) Plan if:

A. The claimant was eligible under the second Plan within twenty-four (24) hours after the termination of the first Plan; and if

B. There was a change in the amount or scope of a Plan's benefits or there was a change in the entity paying, providing, or administering a Plan's benefits; or

C. There was a change from one type of Plan to another (e.g., single employer to multiple employer Plan).

Right to Receive and Release Information. In order to decide if this coordination of benefits provision (or any other Plan's coordination of benefits provision) applies to a claim, the Administrator (without consent of or notice to any person) has a right to:

1. Release to any person, insurance company, administrator, or organization the necessary claim information;

2. Receive from any person, insurance company, administrator, or organization the necessary claim information; and

3. Require any person claiming benefits under the Plan to give the Administrator any information needed by the Administrator to coordinate those benefits.

G.1. Facility of Payment

If another Plan makes a payment that should have been made by the Administrator, then the Administrator has the right to pay the other Plan any amount necessary to satisfy its obligation. Any amount so paid shall be deemed to be benefits paid under the Plan, and, to the extent of such payments, the Administrator shall be fully discharged from liability under the Plan.

G.2. Right to Recover Payment

If the amount of benefit payment exceeds the amount needed to satisfy the Plan obligation under this section, the Plan has the right to recover the excess amount from one or more of the following:

1. Any persons to or for whom such payments were made;

2. Any group insurance companies or service plans; and

3. Any other organizations.

G.3. Failure to Cooperate

Any Covered Person who fails to cooperate in the administration of this provision may be responsible for any charge for services subject to this section, any legal expenses incurred by the Plan to enforce its rights under this section, and may also be terminated from coverage. Cooperation of Covered Persons means that:

1. The Covered Person must file the necessary papers that give the Plan the right to collect payment from the Primary Plan for such services and supplies; and

2. Any benefits paid to the Covered Person by any of the Primary Plans must be refunded to the Plan.

G.4. Medicare's Effect on Coverage Under the Plan

This Plan will be the Primary Plan as it relates to Medicare for active employees age 65 and over and Dependent spouses age 65 and over, as described above in the Coordination of Benefits provision. If a Covered Person chooses to have Medicare be the primary payor, this Plan will not pay any benefits.

H. Cobra Continuation Coverage

COBRA provides for the temporary continuation of health plan benefits for eligible terminated employees, widowed, divorced, or legally separated spouses, and dependent children, where coverage under the employer's health plan would otherwise terminate. Here are some of the important things to consider as a Covered Person decides to accept or refuse this valuable offer:

1. Eligible persons must have been covered under the employer's plan prior to the event that caused their coverage to terminate.

2. There is a time limit to apply for coverage under COBRA. Eligible persons have up to 60 days following the termination of coverage or 60 days following the date the employer gives them notice of their right to elect continuation coverage. The 60 day election period will be measured from the later of the two events.

3. Coverage under the employer's plan has terminated. If a Covered Person is an eligible person who elects to continue coverage within the time allowed, coverage will begin as of the day coverage under the employer's plan ceased.

4. If a Covered Person elects to continue coverage under this provision, the Covered Person will be required to pay the contributions due. The initial contribution, for all periods from the day coverage began up to the current amount due, is payable within forty-five (45) days of the day continuation coverage was applied for. Thereafter, contributions are due on the first of each month for that month until continuation coverage ends.

5. The offer to continue coverage will be made only once. It is a Covered Person's responsibility to enroll promptly and pay contributions as required.

H.1. Who is Eligible for Continued Coverage?

Eligible persons include employees and their covered dependents who lost coverage under the employer's health plan for any of the following reasons. Coverage can be continued for these persons for up to eighteen (18) months due to:

1. Reduction in hours worked that is less, in total, than the plan's minimum requirements.

2. Voluntary or involuntary termination of employment (except for “gross misconduct”).

Other eligible dependents may also apply for continued coverage for up to thirty-six (36) months for the following reasons:

1. A covered employee becomes eligible for Medicare benefits and chooses to disenroll from the Plan, but the spouse and/or dependent children are not yet eligible for Medicare. In this case, coverage for the spouse and dependent children can be continued until the spouse attains age 65.

2. Death of the employee covered under the Plan.

3. Legal separation or divorce from the employee covered under the Plan.

4. Dependent children of an employee when they no longer meet the Plan requirements for eligibility as dependent children.

H.2. Who is not Eligible for Continued Coverage?

1. Employees and/or eligible dependents not covered under the employer plan.

2. Employees who are terminated for “gross misconduct” and their dependents.

3. Employees or dependents who are entitled to Medicare Benefits.

H.3. How Long Does an Eligible Person Have to Elect Continued Coverage?

An eligible person must notify the employer of the decision to accept continued coverage within sixty (60) days of the date coverage terminated, or the date of the employer's election notice, whichever occurs last.

If a Covered Person fails to notify the employer within the time allowed, such Covered Person is no longer eligible to apply.

NOTICE: The eligible person is responsible for notifying the Administrator of a divorce or legal separation, or when a dependent child ceases to be a Dependent under the Plan, within sixty (60) days of such event.

H.4. What Happens if there is Other Continued or Extended Coverage Under this Plan?

If a Covered Person qualifies for another extension or continuation of benefits under any other provision of this Plan, those benefits will run concurrently with COBRA Continuation Coverage. A Covered Person must pay for Continuation Coverage, but if those other concurrently continued benefits are not restricted to a particular medical condition AND are provided at no cost to a Covered Person, such Covered Person will only have to pay for any months of continuation after the free benefits have expired.

If a Covered Person does not elect COBRA Continuation Coverage within the election period noted above, such Covered Person will not be eligible again for Continuation Coverage when the other extension or continuation of benefits expires.

H.5. Extension of Cobra Benefits for Disabled Persons

A Covered Person may be totally disabled on the date of the Qualifying Event or may become totally disabled within 60 days following the qualifying event. If the Qualifying Event is the Employee's termination of employment or reduction in hours, Continuation Coverage may be extended, for that Covered Person only, while such total disability continues for a maximum of eleven (11) months following the expiration of the original eighteen (18) month Continuation Coverage period. In order to obtain this extension of Continuation Coverage, the Covered Person must apply for and be granted total disability benefits under Title II or Title XVI of the Social Security Act. A copy of the determination letter from the Social Security Administration, showing that such total disability existed on the date of the Qualifying Event, or within 60 days following the Qualifying Event, must be submitted to the Plan Administrator prior to the expiration of the original eighteen (18) month Continuation Coverage Period. Proof that Social Security disability benefits have continued will be required for claims payment. This extension of Continuation Coverage will terminate on the first day of the month which begins thirty (30) days from the date that the Covered Person is determined by the Social Security Administration to be no longer totally disabled, or eleven (11) months after the expiration date of the original eighteen (18) month Continuation Coverage period, whichever is sooner.

The monthly cost for this eleven (11) month extension of Continuation Coverage will be 150% of the total average monthly costs as determined by the Administrator on an actuarial basis for coverage of a similarly situated Covered Person for whom a Qualifying Event has not taken place (instead of the 102% which was payable for the first eighteen (18) months of Continuation Coverage.)

H.6. Who Pays for Continued Coverage?

The employee or other covered person must pay the entire monthly cost on a timely basis. Contributions are due on the first of the month for that month. Coverage is subject to the cancellation provisions of the employer's plan if contributions are not paid promptly. If the coverage terminated for non-payment, no reinstatement is possible.

H.7. How much does the Coverage Cost?

The monthly cost for the continuation of coverage will be provided by the employer in the Election Notice. The monthly cost will not exceed the cost indicated above as determined by the Administrator on a actuarial basis for coverage of a similarly situated covered person for whom a qualifying event has not take place.

H.8. Can an Eligible Person Add New Dependents Under this Coverage?

Yes, under the same rules that apply to active employees, but the new dependent may not be a qualified beneficiary.

H.9. Can an Eligible Person Lose Eligibility After Electing Continued Coverage?

Yes, an eligible person's coverage may terminate as described below:

1. At the end of the contribution-paid period, if the next required contribution is not paid within thirty-one (31) days of the date due.

2. The date the person elects coverage under Medicare.

3. The date the eligible person becomes covered under another group health plan. COBRA coverage may be continued, but only if the other group's health plan has a provision, which would reduce or deny charges for a pre-existing condition. The covered person must furnish the Plan Administrator with a copy of the other group health plan's Summary Plan Description (SPD), or Employee Group Health Plan Handbook, containing the pre-existing conditions language. Coverage will be subject to the terms and conditions of the Coordination of Benefits provision contained elsewhere in the Plan, EXCEPT that Continuation Coverage will ALWAYS pay its benefits last after all other plans have paid their benefits. Continuation Coverage will terminate on the expiration of the other plan's pre-existing conditions limitation, or the end of the applicable Continuation Coverage period, whichever is sooner.

4. The date the employer no longer offers a health plan to active employees.

5. At the end of the 18, 29, 36, or other month's eligibility period, whichever applies.

H.10. How Often can Contributions be Changed?

Contributions can be adjusted only when costs for regular employees are also adjusted. This is usually once a year on the plan anniversary, but could be more often if insurance or re-insurance premiums for the employer's plan are changed.

H.11. What are the Benefits Under this Coverage?

Continuation coverage must provide health care benefits that are identical to those provided to employees that are still active and covered under the employer's plan. However, if the employer plan includes Dental and/or Vision (non-core) Benefits in the same plan as Medical (core) Benefits, eligible persons may elect to continue only the Medical coverage. The employer is not required to allow continuation of “NON-CORE” coverage without the Medical (core) benefits.

If the employer maintains separate stand alone plans for different types of benefits, eligible persons must be given the opportunity to elect continuation coverage separately for each plan.

Life insurance and Accidental Death and Dismemberment coverage cannot be continued under COBRA.

Since COBRA laws are subject to change and interpretation, any interested employee or dependent should consult with a personal attorney for a detailed explanation of these laws and how they may apply to a particular circumstance.

I. Special Continuation Coverage for a Spouse

If the coverage for a Covered Spouse would otherwise end because the Covered Employee's coverage ends due to:

1. the death of the Covered Employee, or

2. an Employee becomes eligible for Medicare and has elected to terminate coverage under this Plan,

then the Covered Spouse may elect to continue coverage under this Plan as if he/she were a Covered Employee until such Covered Spouse attains the age of 65. This special continuation coverage will automatically terminate if:

1. A Continuing spouse attains the age of 65 or

2. The Continuing spouse becomes eligible for Medicare or obtains other group medical insurance coverage from any source, or

3. The Continuing spouse fails to make any required contribution when it is due, subject to a 31-day grace period.

J. Family and Medical Leave Act (FMLA)

If a Covered Employee ceases active service due to an Employer approved Family Medical Leave of Absence in accordance with the requirements of Public Law 103-3, coverage will be continued under the same terms and conditions which would have been provided had the Covered Employee continued active service, provided the employee continues to pay the contributions, if required. Contributions will remain at the same Employer/employee percentage level as on the date immediately prior to the leave (unless contributions change for other employees in the same classification).

If the Covered Employee does not return to active service after the approved Family Medical Leave or if the Covered Employee has given the Employer notice of intent not to return to active service during the leave, coverage may be continued under the Continuation of Coverage (COBRA) provision of this Plan.

If the Covered Employee fails to make the required contribution for coverage to continue during FMLA leave, within thirty (30) days after the date the contribution was due, the Covered Employee's coverage will terminate effective on the date the contribution was due.

If coverage under this Plan was terminated during an approved FMLA leave due to non-payment of required contributions by the employee and the employee returns to active service immediately upon completion of that leave, coverage will be reinstated on the date the employee returns to active service, without having to satisfy any waiting period or the Pre-existing Conditions limitations in this Plan, provided the employee makes any necessary contributions and enrolls for coverage within thirty-one (31) days of return to active service.

K. Statement of Erisa Rights

1. As a participant in the Plan, Covered Persons are entitled to certain rights and protections under the Employee Retirement Income Security Act of 1974 (ERISA). ERISA provides that all Plan participants shall be entitled to:

A. Examine, without charge, at the Plan Administrator's Office, all Plan documents, including insurance contracts and copies of any documents filed by the Plan with the U.S. Department of Labor (such as detailed annual reports and Plan Descriptions).

B. Obtain copies of all Plan Documents and other Plan information, upon written request to the Plan Administrator. The Administrator may make a reasonable charge for the copies.

C. Receive a summary of the Plan's annual financial report. The Plan Administrator is required by law to furnish each participant with a copy of the summary annual report.

2. In addition to creating rights for Plan participants, ERISA imposes duties upon the persons who are responsible for the operation of the Employee's benefit plan.

3. The people who operate this Plan, called “fiduciaries” or “Trustees” of the Plan, have a duty to do so prudently and in the interest of all Plan Participants and beneficiaries.

4. No one, including an employer, may fire a participant or otherwise discriminate against participants in any way to prevent them from obtaining a welfare benefit or exercising their rights under ERISA.

5. If a Covered Person's claim for a welfare benefit is denied in whole or in part, they must receive a written explanation of the reason for the denial. Covered Persons have the right to have the Plan review and reconsider a claim.

6. Under ERISA, there are steps Covered Persons can take to enforce the above rights. For instance, if a Covered Person requests materials from the Plan and does not receive them within thirty (30) days, they may file suit in Federal Court. In such a case, the court may require the Plan Administrator to provide the materials and pay up to $100.00 a day until the requested materials are received, unless the materials are not sent because of reasons beyond the control of the Administrator. If a Covered Person has a claim for benefits which is denied or ignored, in whole or in part, such Covered Person may file suit in a State or Federal court.

7. If it should happen that the Plan fiduciaries misuse the Plan's money or if Covered Persons are discriminated against for asserting their rights, they may seek assistance from the U.S. Department of Labor, or they may file suit in Federal Court. The court will decide who should pay court costs and legal fees. If Covered Persons are successful, the court may order the person sued to pay these costs and fees. If Covered Persons lose, the court may order them to pay these costs and fees, for example, if it finds their claim is frivolous.

8. If Covered Persons have any questions about this Plan of benefits, they should contact the Plan Administrator or the company personnel office. If they have any questions about this statement or about their rights under ERISA, they should contact the nearest Office of the Pension and Welfare Benefits Administration, U.S. Department of Labor, listed in the telephone directory, or the Division of Technical Assistance and Inquiries, Pension and Welfare Benefits Administration, U. S. Department of Labor, 200 Constitution Avenue N. W., Washington, D. C., 20210.

Therefore, the Board of Trustees of the ______ has adopted this Plan Document at a meeting duly held on ______, to be effective on ______.

______

Trust Representative/Title

In view of the many possible embodiments to which the principles of this invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

We claim:

1. A method for providing health care benefits to a participant of an organization, the method comprising:
establishing a medical expense spending account for the participant;
transferring funds from the organization to the participant medical expense spending account;
using funds in the participant medical expense spending account to pay for health care expenses incurred by the participant; and
removing funds from the participant medical expense spending account, distributing a first portion of the removed funds to the organization, and distributing a second portion of the removed funds to the participant.

2. The method of claim 1 wherein establishing comprises establishing the participant medical expense spending account in accordance with Internal Revenue Service Code section 213.

3. The method of claim 1 wherein using funds in the participant medical expense spending account comprises paying for health care expenses incurred by the participant until a given amount of funds has been paid.

4. The method of claim 1 wherein removing funds is performed periodically.

5. The method of claim 1 wherein distributing a first portion of the removed funds compensates, at least in part, the organization for the funds transferred from the organization to the participant medical expense spending account.

6. The method of claim 1 wherein distributing a first portion of the removed funds comprises distributing from 0% to 50% of the removed funds to the organization.

7. The method of claim 1 wherein distributing a first portion of the removed funds comprises distributing a portion based, at least in part, on a sum of funds removed from the participant medical expense spending account and funds from other participant medical expense spending accounts.

8. The method of claim 1 wherein distributing a second portion of the removed funds comprises distributing a portion based, at least in part, on a sum of funds removed from the participant medical expense spending account and funds from other participant medical expense spending accounts.

9. The method of claim 1 further comprising:
obtaining health care insurance coverage for the participant, wherein obtaining health care insurance coverage comprises paying, by the organization, a premium for the health care insurance coverage;
wherein distributing a first portion of the removed funds compensates, at least in part, the organization for paying the premium for the health care insurance coverage.

10. A computer-readable medium having instructions for performing a method for providing health care benefits to a participant of an organization, the method comprising:
establishing a medical expense spending account for the participant;
transferring funds from the organization to the participant medical expense spending account;
using funds in the participant medical expense spending account to pay for health care expenses incurred by the participant; and
removing funds from the participant medical expense spending account, distributing a first portion of the removed funds to the organization, and distributing a second portion of the removed funds to the participant.

11. A method for providing health care benefits to a participant of an organization, the method comprising:
establishing a medical expense spending account for the participant;
transferring funds from the organization to the participant medical expense spending account;
obtaining health care insurance coverage for the participant, the health care insurance coverage having a per-participant deductible;
for health care expenses incurred by the participant up to an amount of funds in the participant medical expense spending account, paying for the health care expenses with funds in the participant medical expense spending account;
for health care expenses incurred by the participant beyond an amount of funds in the participant medical expense spending account and less than the per-participant deductible of the health care insurance coverage, paying for the health care expenses with funds provided by the participant;
for health care expenses incurred by the participant beyond the per-participant deductible of the health care insurance coverage, paying for the health care expenses with funds provided by the health care insurance coverage; and
removing funds from the participant medical expense spending account, distributing a first portion of the removed funds to the organization, and distributing a second portion of the removed funds to the participant.

12. The method of claim 11 wherein establishing comprises establishing the participant medical expense spending account in accordance with Internal Revenue Service Code section 213.

13. The method of claim 11 wherein removing funds is performed periodically.

14. The method of claim 11 wherein distributing a first portion of the removed funds compensates, at least in part, the organization for the funds transferred from the organization to the participant medical expense spending account.

15. The method of claim 11 wherein distributing a first portion of the removed funds comprises distributing from 0% to 50% of the removed funds to the organization.

16. The method of claim 11 wherein distributing a first portion of the removed funds comprises distributing a portion based, at least in part, on a sum of funds removed from the participant medical expense spending account and funds from other participant medical expense spending accounts.

17. The method of claim 11 wherein distributing a second portion of the removed funds comprises distributing a portion based, at least in part, on a sum of funds removed from the participant medical expense spending account and funds from other participant medical expense spending accounts.

18. The method of claim 11 wherein obtaining health care insurance coverage comprises paying, by the organization, a premium for the health care insurance coverage and wherein distributing a first portion of the removed funds compensates, at least in part, the organization for paying the premium for the health care insurance coverage.

19. A computer-readable medium having instructions for performing a method for providing health care benefits to a participant of an organization, the method comprising:
establishing a medical expense spending account for the participant;
transferring funds from the organization to the participant medical expense spending account;
obtaining health care insurance coverage for the participant, the health care insurance coverage having a per-participant deductible;
for health care expenses incurred by the participant up to an amount of funds in the participant medical expense spending account, paying for the health care expenses with funds in the participant medical expense spending account;
for health care expenses incurred by the participant beyond an amount of funds in the participant medical expense spending account and less than the per-participant deductible of the health care insurance coverage, paying for the health care expenses with funds provided by the participant;
for health care expenses incurred by the participant beyond the per-participant deductible of the health care insurance coverage, paying for the health care expenses with funds provided by the health care insurance coverage; and
removing funds from the participant medical expense spending account, distributing a first portion of the removed funds to the organization, and distributing a second portion of the removed funds to the participant.

20. A method for distributing funds in a medical expense spending account established for a participant of an organization, the method comprising:
removing funds from the participant medical expense spending account;
distributing a first portion of the removed funds to the organization; and
distributing a second portion of the removed funds to the participant.

21. The method of claim 20 wherein distributing a first portion of the removed funds compensates, at least in part, the organization for funds transferred from the organization to the participant medical expense spending account.

22. The method of claim 20 wherein distributing a first portion of the removed funds compensates, at least in part, the organization for paying a premium for health care insurance coverage for the participant.

23. The method of claim 20 wherein distributing a first portion of the removed funds comprises distributing from 0% to 50% of the removed funds to the organization.

24. The method of claim 20 wherein distributing a first portion of the removed funds comprises distributing a portion based, at least in part, on a sum of funds removed from the participant medical expense spending account and funds from other participant medical expense spending accounts.

25. The method of claim 20 wherein distributing a second portion of the removed funds comprises distributing a portion based, at least in part, on a sum of finds removed from the participant medical expense spending account and funds from other participant medical expense spending accounts.

26. A computer-readable medium having instructions for performing a method for distributing funds in a medical expense spending account established for a participant of an organization, the method comprising:
removing funds from the participant medical expense spending account;
distributing a first portion of the removed funds to the organization; and
distributing a second portion of the removed funds to the participant.

27. A method for administering a health care benefits plan for an organization with a participant, the method comprising:
establishing a medical expense spending account for the participant;
receiving funds from the organization and transferring the funds to the participant medical expense spending account; and
removing funds from the participant medical expense spending account, distributing a first portion of the removed funds to the organization, and distributing a second portion of the removed funds to the participant.

28. The method of claim 27 wherein establishing comprises establishing the participant medical expense spending account in accordance with Internal Revenue Service Code section 213.

29. The method of claim 27 wherein removing funds is performed periodically.

30. The method of claim 27 wherein distributing a first portion of the removed funds compensates, at least in part, the organization for the funds received from the organization and transferred to the participant medical expense spending account.

31. The method of claim 27 wherein distributing a first portion of funds comprises distributing from 0% to 50% of the removed funds to the organization.

32. The method of claim 27 wherein distributing a first portion of the removed funds comprises distributing a portion based, at least in part, on a sum of funds removed from the participant medical expense spending account and funds from other participant medical expense spending accounts.

33. The method of claim 27 wherein distributing a second portion of the removed funds comprises distributing a portion based, at least in part, on a sum of funds removed from the participant medical expense spending account and funds from other participant medical expense spending accounts.

34. The method of claim 27 further comprising:
assisting the organization in processing claims for payment of health care expenses incurred by the participant, wherein at least some of the claims are paid, at least in part, using finds in the participant medical expense spending account.

35. The method of claim 34 further comprising:
providing periodic reports to the organization regarding health care expense claims paid.

36. The method of claim 34 wherein using funds in the participant medical expense spending account comprises paying for health care expenses incurred by the participant until a given amount of funds has been paid.

37. The method of claim 27 further comprising:
assisting the organization in obtaining health care insurance coverage for the participant, wherein obtaining health care insurance coverage comprises paying, by the organization, a premium for the health care insurance coverage;
wherein distributing a first portion of the removed funds compensates, at least in part, the organization for paying the premium for the health care insurance coverage.

38. The method of claim 27 further comprising:
assisting the organization in enrolling the participant in the health care insurance benefits plan.

39. A computer-readable medium having instructions for performing a method for administering a health care benefits plan for an organization with a participant, the method comprising:
establishing a medical expense spending account for the participant;
receiving funds from the organization and transferring the funds to the participant medical expense spending account; and
removing funds from the participant medical expense spending account, distributing a first portion of the removed funds to the organization, and distributing a second portion of the removed funds to the participant.

40. A system for administering a health care benefits plan for an organization with a participant, the system comprising:
a computing device for establishing a medical expense spending account for the participant, for transferring funds to the participant medical expense spending account, and for removing funds from the participant medical expense spending account; and
an interface to a communications network enabling the computing device to receive funds from the organization, to distribute a first portion of the removed funds to the organization, and to distribute a second portion of the removed funds to the participant.

41. A computer-readable medium containing instructions for providing a system for administering a health care insurance benefits plan for an organization with a participant, the system comprising:
a computing device for establishing a medical expense spending account for the participant, for transferring funds to the participant medical expense spending account, and for removing funds from the participant medical expense spending account; and
an interface to a communications network enabling the computing device to receive funds from the organization, to distribute a first portion of the removed funds to the organization, and to distribute a second portion of the removed funds to the participant.
